(19) United States
(12) Patent Application Publication
(10) Pub. No.: US 2005/0002751 A1
(43) Pub. Date: Jan. 6, 2005

(54) Fixing plugs for anchoring in an irregular hole

(75) Inventors: Janusz Lucien Holland, Edgbaston (GB); Mark Christopher Hughes, Stourbridge (GB)

Correspondence Address: NIKOLAI & MERSEREAU, P.A., 900 SECOND AVENUE SOUTH, SUITE 820, MINNEAPOLIS, MN, 55402, US

(73) Assignee: Realty Products Limited, Birmingham (GB)

(21) Appl. No.: 10/868,452

(22) Filed: Jun. 11, 2004

Related U.S. Application Data
(63) Continuation of application No. PCT/GB02/05683, filed on Dec. 13, 2002.

(30) Foreign Application Priority Data
Dec. 13, 2001 (GB) 0129824.9

(51) Int. Cl. F16B 1/00

(52) U.S. Cl. 411/80.1

(57) ABSTRACT

A fixing plug for anchoring in an irregular hole in a substrate, the plug having an elongate body with an internal bore for receiving a screw, closure means adapted to close the opening of said hole, at least one opening in said closure means, and a plurality of support fingers extending radially outwardly from said body, said support fingers being resiliently detected by contact with walls of the hole on insertion of the plug into the hole, the fingers sensing to hold the plug substantially centrally within the hole.

The present invention relates to a fixing plug for anchoring in a hole. More particularly, but not exclusively, it relates to a fixing plug for anchoring in an irregular hole.

It is well known to anchor a screw in a wall or other substrate (hereinafter referred to generally as a wall). In general, it is advisable to drill a hole of diameter slightly larger than that of the screw, fit into the wall an expandable plastic fixing plug and then to insert the screw to expand the plug to hold the ensemble securely within the hole and thereby to the wall.

It is also well known that the fixing position on the wall may be less than ideal, either by disposition or by accident. It may be the case that the fixing is in a soft wall, for example a cob wall or a previously repaired wall. Another possibility is that the fixing point falls in a mortar joint or in which the drilled hole has opened too much for fitting a standard plug. Inhomogeneities in the material of the wall may deflect a drill hole. A further possibility is that a previously fitted fixing has worked loose, thereby damaging the hole, so that a replacement fixing is required.

In all these cases, which will collectively be referred to herein as irregular holes, there is a need for a secure fixing which includes consolidating the walls of the hole and centring the fixing in that hole.

It is known to use fixings that may be held securely in place in suitable holes by means of adhesives, grouts, and the like, and UK Patent No. 1587469 provides an example thereof. However, the fixing disclosed therein is only usable in a neat cylindrical hole of a particular diameter, relying as it does on a series of generally disc-shaped flanges disposed transversely to the shaft of the fixing, which contact internal walls of the cylindrical hole and maintain the fixing in place while the adhesive, etc, sets. If the hole is not precisely configured to receive the fixing, few of these flanges will be in supporting contact, and the fixing will probably not remain in place while the adhesive, etc, sets.

It is therefore an object of the present invention to provide a fixing plug adapted for use in an irregular hole. It is a further object of the present invention to provide a method of securing such a fixing plug in such an irregular hole.

According to the present invention there is provided a fixing plug for anchoring in an irregular hole in a substrate, the plug having an elongate body with an internal bore for receiving a screw, closure means adapted to close the opening of said hole, at least one opening in said closure means, and a plurality of support fingers extending radially outwardly from said body, said support fingers being resiliently deflected by contact with walls of the hole on insertion of the plug into the hole, the fingers sensing to hold the plug substantially centrally within the hole.

Preferably the support fingers are in the form of fins which extend longitudinally along the elongate body.

The body may be substantially cylindrical or frustoconical.

Preferably, each fin is so resiliently deformable that any part thereof along the length of any one of them may be deformed to accommodate contact with an irregularity in the walls of the hole.

Each fin may extend along a major part of the length of the elongate body.

Preferably each fin has a marginal longitudinal edge portion curved in section.

There may be a gap between the closure means and a respective end of each fin.

The fins may be disposed generally equiangularly around the body of the plug.

There may be at least four fins, optionally at least six.

Each fin may, in its non-deformed conformation, taper generally radially inwardly from an end adjacent the closure means to an end remote therefrom.

Advantageously, there may be provided additional projections to improve contact with the walls of the hole.

The closure means may include two openings, one adapted to receive a settable adhesive mixture into a plenum formed between the fixing plug and the walls of the hole, and the other to vent said plenum.

Either one of said openings may act as said receiving opening, in which case the other said opening may act as said venting opening.

The closure means may comprise substantially planar flange means disposed transversely to the body of the plug.

The flange means may be adapted to contact a surface of the substrate adjacent the hole.

The closure means preferably comprises an annulus of greater diameter than any overall diameter of the body and the support fingers of the plug at any point along the length of the body.

The plug preferably comprises a resiliently deformable plastics material.

Advantageously, the plug comprises an injection-mouldable thermoplastics material, such as polyethylene, polypropylene, nylon, polyvinylchloride or an acrylic copolymer.

The bore of the plug may be provided with means to engage with a screw thread of a screw.

Optionally, the bore may be provided with a plurality of inwardly projecting elongate ridges which may engage with the screw thread of a screw.

According to a second aspect of the present invention, there is provided a method of anchoring in an irregular hole in a substrate comprising the steps of providing a fixing plug as described above, inserting said plug into the hole so as to be substantially centrally located therein, inserting through said opening in the closure means a settable adhesive composition in sufficient quantity as to fill the plenum between the fixing plug and the walls of the hole, and thereafter inserting a screw into the internal bore of the body.

Preferably, the screw is inserted after a delay period during which setting of the adhesive composition has substantially progressed, for example when the adhesive composition is substantially solid but not rigid.

Advantageously, the plug is inserted into the hole so that the closure means contacts a surface of the substrate around the hole substantially sealingly.

The adhesive composition is preferably a single component adhesive composition.

The adhesive composition may be a water-based latex or emulsion adhesive composition, optionally one comprising polyvinyl acetate or poly(meth)acrylate homopolymers or copolymers.

An embodiment of the present invention will now be more particularly described by way of example and with reference to the accompanying drawings, in which:

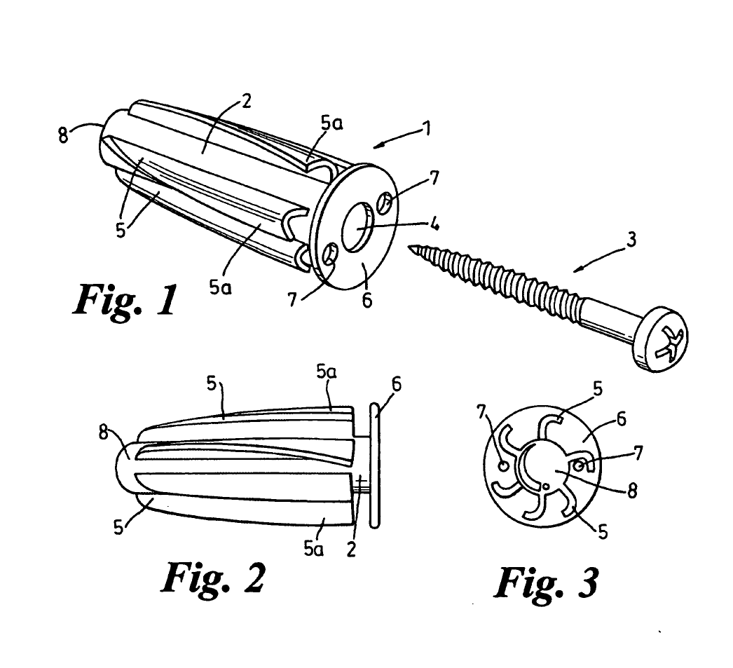

FIG. 1 is a perspective view of the plug as if in position within a hole;

FIG. 2 is a side elevation of the fixing plug of FIG. 1;

FIG. 3 is an end view of the plug of FIG. 2;

FIG. 4 is a longitudinal sectional view of the plug about to enter a hole in the wall;

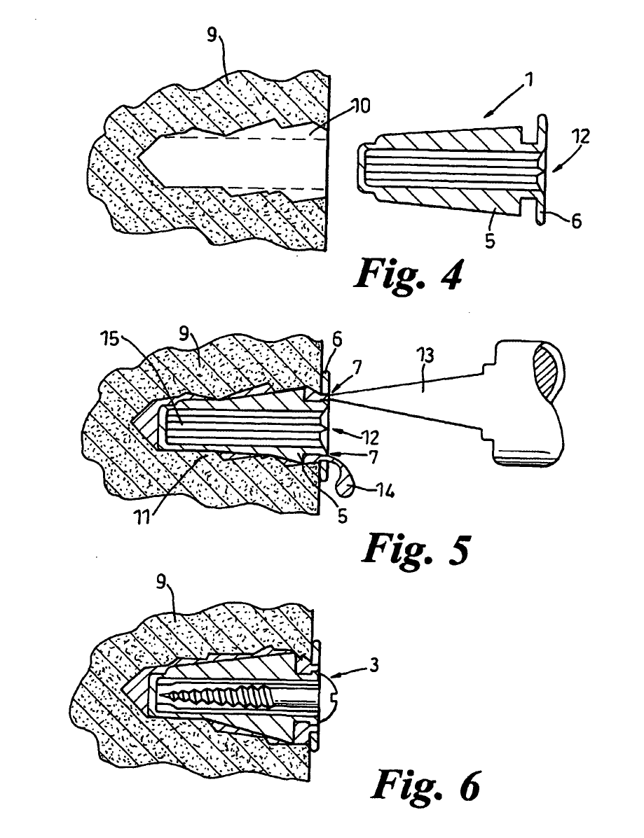

FIG. 5 is a longitudinal sectional view of the plug inserted in the hole and with adhesive material inserted; and

FIG. 6 is a view of the plug adhered into the wall and with a screw fixed.

Referring now to the drawings and to FIG. 1 in particular, a fixing plug 1 comprises an elongate, substantially cylindrical body 2 with a bore adapted to receive a screw 3 extending substantially coaxially through the body 2 from an aperture 4 in a proximal end of the plug 1. The distal end 8 of the body 2 is closed, and conveniently has a rounded external form. The body 2 is provided with radially directed support fingers, preferably in the form of six longitudinal fins 5, which are disposed generally parallelly and equally spaced around the body 2. Prior to insertion of the plug 1 into a hole, the fins 5 each extend radially outwardly from the body 2, but they are resiliently deflectable, in particular by contact with an internal surface of the hole, as is represented by the conformation of the fins 5 shown in FIGS. 1 to 3. Preferably as shown, each fin has a marginal longitudinal edge portion 5a which is curved in section and extends at least partially along its length. The edge portion 5a helps deflection of the fin during insertion of the plug.

The proximal end of the body 2 is provided with a circular flange, disposed transversely thereto, and dimensioned to close off a hole into which the plug 1 may be inserted. The flange 6 is provided with two openings 7 extending therethrough, leading to an interior of said hole when the plug 1 is in place.

The plug 1 is made of an injection-moulded thermoplastics material, such as polyethylene or polypropylene.

Turning now to FIGS. 4 to 6, a method of use of the plug 1 is shown. A wall 9 has an irregular hole 10 therein. This irregularity may be due to poor drilling of the hole 10, to the nature of the material of the wall 9, or to damage caused when a previous fixing was deliberately or accidentally removed therefrom. Any loose material is first cleared from the hole 9.

A plug 1 is selected which is slightly shorter than the depth of the hole 10, but which is provided with fins 5 dimensioned so that the overall diameter of the fins 5 and the body 2 is at least slightly greater than that of the hole 10, and which has a flange 6 broader than the diameter of the hole 10 at a surface of the wall 9.

The plug 1 is inserted into the hole 10, and the fins 5 are deformed by contact with irregularities 11 in an internal surface of the hole 10, As shown, the fins 5 are sufficiently deformable that each fin 5 may deform differently along its length to conform engagingly to a local profile of the internal surface of the hole 10. The plug 1 is inserted into the hole 10 until the flange 6 contacts the surface of the wall 9 on each side of the hole 10. It thus substantially seals off the interior of the hole 10 and leaves the bore 12 of the plug 1 disposed substantially perpendicularly to the surface of the wall 9, and substantially centrally within the hole 10. The fins 5, in contact with the internal surface of the hole 10, support the plug 1 in this advantageous orientation.

As shown in FIG. 5, a nozzle 13 of a reservoir of adhesive is then presented up to a first opening 7 of the flange 6, and adhesive is injected through said first opening 7 into a plenum formed between the body 2 of the plug 1 and the internal surface of the hole 10. Air displaced thereby exits the plenum through the second opening 7. As the fins 5 do not meet the flange 6, nor extend all the way to the distal end 8 of the body 2, the adhesive may easily flow around the plug 1 to reach all parts of the plenum. When the plenum is substantially full of adhesive, an overspill 14 of adhesive begins to exit through the second opening 7. Injection of adhesive is stopped, and the overspill 14 is wiped away. Preferably the elongate body 2 is continuously wall so that adhesive does not penetrate into the internal bore 4.

The adhesive is then left to set until a point is reached when it has set sufficiently firmly to hold the plug 1 securely in place, but it still retains a degree of resilience. The screw 3 may then be inserted into the bore 12 of the plug 1 as for a conventional wall fixing plug, expanding the body 2 of the plug 1 and the surrounding adhesive slightly radially outwardly to increase engagement with the internal surface of the hole 10. Longitudinal ridges 15 may optionally be provided, extending along an internal surface of the bore 12, to assist engagement with a screw thread of the screw 3.

The adhesive is then left to set completely. The screw 3 is held securely in engagement with the plug 1, which is itself now securely bonded to the internal surface of the hole 10 by the adhesive. The irregularities 11 of the hole 10 are, if anything, an advantage, as they assist in the “locking” of the adhesive, and thus the plug 1 and the screw 3, into the wall 9.

The fins 5 may be adapted for keying into the adhesive to prevent axial withdrawal of the plug 3, for example the fins 5 may be discontinuous along their length to provide spaces into which adhesive may penetrate.

The adhesive used may be a solvent-based or a two-component adhesive, but the most suitable adhesives are found to be water-based latex or emulsion systems, comprising polyvinyl acetate, polyacrylates or copolymers based thereon. These have the correct balance of “grab” and “tack” to hold the plug in place, they are strong and tough when set, they flow well, so that they can fill substantially all the irregularities of a hole, and they are safe and convenient for domestic use. With such adhesives, it is found that the screw may often be safely inserted no more than an hour after injection of the adhesive.

This form of plug is particularly suitable for use when mounting a fixing to difficult or porous materials, in which a neat, precise cylindrical hole is difficult to create.

Filling in a defective hole and drilling a new hole into the filling material requires a high degree of skill, whereas positioning a fixing in the existing hole and then filling in around it is easier, particularly when performed as described above.

It also may occur, for example, that when an item is to be mounted to a wall via a plurality of holes, at least one of the holes will be defective in some way. Either a new set of holes must be drilled, displaced from the originals, or a means of fixing securely via the defective hole is required. This is provided in the above invention.

1. A fixing plug for anchoring in an irregular hole in a substrate, the plug having an elongate body with an internal bore for receiving a screw, closure means adapted to close the opening of said hole, at least one opening in said closure means, and a plurality of support fingers extending radially outwardly from said body, said support fingers being resiliently deflected by contact with walls of the hole on insertion of the plug into the hole, the fingers sensing to hold the plug substantially centrally within the hole.

2. A fixing plug according to claim 1 wherein the support fingers are in the form of fins which extend longitudinally along the elongate body.

3. A fixing plug according to claim 2 wherein each fin is so resiliently deformable that any part thereof along the length of any one of them may be deformed to accommodate contact with an irregularity in the walls of the hole.

4. A fixing plug according to claim 2 or 3 wherein each fin has a marginal longitudinal edge portion which is curved in section.

5. A fixing plug according to claim 1, 2 or 3 wherein the closure means includes two openings, one adapted to receive a settable adhesive mixture into a plenum formed between the fixing plug and the walls of the hole, and the other to vent said plenum.

6. A fixing plug according to claim 1 wherein the closure means comprises an annulus of greater diameter than any overall diameter of the body and the support fingers of the plug at any point along the length of the body.

7. A method of anchoring in an irregular hole in a substrate comprising the steps of providing a fixing plug according to claim 1, inserting said plug into the hole so as to be substantially centrally located therein, inserting through said opening in the closure means a settable adhesive composition in sufficient quantity as to fill the plenum between the fixing plug and the walls of the hole, and thereafter inserting a screw into the internal bore of the body.
